(19) United States
(12) Patent Application Publication
(10) Pub. No.: US 2018/0170193 A1
(43) Pub. Date: Jun. 21, 2018

(54) MULTI-FUNCTIONAL ON-VEHICLE POWER CONVERTER AND ELECTRIC VEHICLE COMPRISING THE SAME

(71) Applicant: NIO NEXTEV LIMITED, Hong Kong (CN)

(72) Inventors: Liang HE, Shanghai (CN); Xiaojia DENG, Shanghai (CN); Jie FANG, Shanghai (CN); Xiao GONG, Shanghai (CN); Shengjie YUAN, Shanghai (CN); Jun FAN, Shanghai (CN); Wei QIAN, Shanghai (CN)

(21) Appl. No.: 15/850,725

(22) Filed: Dec. 21, 2017

(30) Foreign Application Priority Data
Dec. 21, 2016 (CN) 201611190450.7

(51) Int. Cl. B60L 11/18; H02J 7/00

(52) U.S. Cl. CPC B60L 11/1812; B60L 11/182; B60L 2210/10; H02J 7/007; B60L 11/1838

(57) ABSTRACT

The invention relates to automotive electronic and electrical technology, and in particular, to a multi-functional on-vehicle power converter for electric vehicle as well as an electric vehicle comprising the multi-functional on-vehicle power converter. In the invention, by introducing two independent switches, a rectifying circuit, a filtering circuit, an output EMC circuit and a corresponding control unit (e.g., a CAN communication circuit and a signal collecting circuit, etc.) can be shared among a conductive charging converter, an on-vehicle part of a wireless charging converter and a DC-DC converter, and a convenient and swift switch can be realized among the three operational modes. In addition, since the circuit units are shared, the number of cooling circuits is also reduced, and the occupied space and weight of the on-vehicle power converter are decreased.

### CROSS-REFERENCE TO RELATED APPLICATIONS

This application claims the benefit of China Patent Application No. 201611190450.7 filed Dec. 21, 2016, the entire contents of which are incorporated herein by reference.

### FIELD OF THE INVENTION

The invention relates to automotive electronic and electrical technology, and in particular, to a multi-functional on-vehicle power converter for electric vehicle as well as an electric vehicle comprising the multi-functional on-vehicle power converter.

### BACKGROUND

A charging convert for electric vehicle is used for charging a power battery of electric vehicle when the electricity quantity of the power battery is too low, thus providing power for driving the electric vehicle. The charging convert for electric vehicle comprises conductive charging (on-vehicle charging/not-on-vehicle charging) converter and non-conductive charging (wireless charging) converter.

The non-conductive wireless charging converter is divided into an on-vehicle unit and a ground unit. Through a cooperative operation of these two units, the energy from AC grid is converted into a DC power so as to charge the power battery. FIG. 1 is a circuit diagram of the wireless charging converter according to the prior art. The wireless charging converter 100 shown in FIG. 1 comprises a ground unit 110 and an on-vehicle unit 120. The ground unit 110 comprises an input electromagnetic compatible (EMC) circuit 111, a power factor correction circuit 112 connected with the input EMC circuit 111, a DC-DC primary side rectifying circuit 113 connected with the power factor correction circuit 112, and an isolation transformer T1, a primary side of which is connected with an output side of the DC-DC primary side rectifying circuit 113. The on-vehicle unit 120 comprises a secondary side rectifying circuit 121 and an output electromagnetic compatible circuit 122 connected with the secondary side rectifying circuit 121, wherein an input side of the secondary side rectifying circuit 121 is connected with a secondary side of the isolation transformer T1.

During charging, the electrical energy of the AC grid is input to the DC-DC primary side rectifying circuit 113 after passing the input EMC circuit 111 and the power factor correction circuit 112, and a high-frequency direct current is generated at the primary side of the isolation transformer T1 after a DC-DC conversion. The secondary side rectifying circuit 121 rectifies a high-frequency direct current from the secondary side of the isolation transformer T1, and outputs it to the high voltage power battery via the output electromagnetic compatible circuit 122.

The conductive on-vehicle charging converter is disposed on the electric vehicle, and converts energy from AC grid into DC power so as to charge the power battery. FIG. 2 is a circuit diagram of an on-vehicle charging converter according to the prior art. The on-vehicle charging converter 200 shown in FIG. 2 comprises an input electromagnetic compatible (EMC) circuit 211, a power factor correction circuit 212 connected with the input EMC circuit 211, a DC-DC primary side rectifying circuit 213 connected with the power factor correction circuit 212, an isolation transformer T2, a secondary side rectifying circuit 214, and an output electromagnetic compatible circuit 215 connected with the secondary side rectifying circuit 214, wherein a primary side of the isolation transformer T2 is connected with an output side of the DC-DC primary side rectifying circuit 213, and a secondary side of the isolation transformer T2 is connected with an input side of the secondary side rectifying circuit 214.

During charging, the electrical energy of the AC grid is input to the DC-DC primary side rectifying circuit 213 after passing the input EMC circuit 211 and the power factor correction circuit 212, and a high-frequency direct current is generated at the primary side of the isolation transformer T2 after a DC-DC conversion. The secondary side rectifying circuit 214 rectifies a high-frequency direct current from the secondary side of the isolation transformer T2, and outputs it to the high voltage power battery via the output electromagnetic compatible circuit 215.

On the other hand, the electric vehicle is also equipped with a DC-DC converter which can convert high voltage power of the power battery into low voltage power so as to supply power to low voltage electrical components of the electric vehicle and to charge low voltage battery.

FIG. 3 is a circuit diagram of a DC-DC converter according to the prior art. The DC-DC converter 300 shown in FIG. 3 comprises an input electromagnetic compatible (EMC) circuit 311, a DC-DC primary side rectifying circuit 312 connected with the input EMC circuit 311, an isolation transformer T3, a DC-DC secondary side rectifying circuit 313, and an output electromagnetic compatible circuit 314, wherein an output side of the DC-DC primary side rectifying circuit 312 is connected with a primary side of the isolation transformer T3, and an input side of the DC-DC secondary side rectifying circuit 313 is connected with a secondary side of the isolation transformer T3.

In operation, the DC electrical energy of the high voltage power battery is input to the DC-DC primary side rectifying circuit 312 via the input EMC circuit 311, and a high-frequency direct current is generated at the primary side of the isolation transformer T3 after a DC-DC conversion. The DC-DC secondary side rectifying circuit 313 rectifies and filters a high-frequency direct current from the secondary side of the isolation transformer T3, and outputs it to low voltage electrical components or low voltage battery via the output electromagnetic compatible circuit 314.

The above conductive on-vehicle charging converter, non-conductive wireless charging converter and DC-DC converter all have disadvantages of high manufacture cost, bulky volume, heavy weight, etc. All these are disadvantageous for reducing the cost and energy consumption of electric vehicles. Therefore, there is an urgent need for an on-vehicle power converter that can solve that above technical problem.

### SUMMARY OF THE INVENTION

An object of the invention is to provide an on-vehicle power converter for electric vehicle, which has advantages of compact structure, light weight, small space occupied, etc.

The on-vehicle power converter for electric vehicle according to an aspect of the invention at least comprises a DC-DC converter, and an on-vehicle unit of a wireless charging converter, wherein a primary side of the DC-DC converter and a secondary side of the wireless charging converter share a rectifying circuit, a filtering circuit and an electromagnetic compatible circuit.

Preferably, the above on-vehicle power converter for electric vehicle further comprises an on-vehicle charging converter, and the filtering circuit and the electromagnetic compatible circuit are also shared by a secondary side of the on-vehicle charging converter.

Preferably, the above on-vehicle power converter for electric vehicle comprises a first switch, a second switch, a first isolation transformer, a second isolation transformer, a first electromagnetic compatible circuit, a DC-DC converter secondary side unit connected with a secondary side of the first isolation transformer, an on-vehicle charging converter primary side unit connected with a primary side of the second isolation transformer, a first rectifying circuit and a second rectifying circuit,

wherein an input side of the first rectifying circuit is connected with a primary side of the first isolation transformer via the firs switch, and is connected with a ground unit of the wireless charging converter via the second switch, an input side of the second rectifying circuit is connected with a secondary side of the second isolation transformer, and the output sides of the first rectifying circuit and the second rectifying circuit are connected with the first electromagnetic compatible circuit in parallel; and

wherein when the first switch is closed and the second switch is opened, a high voltage direct current output from a high voltage power battery is converted into a low voltage direct current via the first rectifying circuit and the DC-DC converter secondary side unit; when the first switch is opened and the second switch is closed, a direct current from the ground unit of the wireless charging converter is converted, via the first rectifying circuit, into a high voltage direct current to be output to the high voltage power battery; and when both the first switch and the second switch are opened, a direct current output from the on-vehicle charging converter primary side unit is converted, via the second rectifying circuit, into a high voltage direct current to be output to the high voltage power battery.

Preferably, the above on-vehicle power converter for electric vehicle comprises a first switch, a second switch, an isolation transformer, a DC-DC converter secondary side unit, a first electromagnetic compatible circuit and a first rectifying circuit,

wherein an input side of the first rectifying circuit is connected with a primary side of the isolation transformer via the first switch, and is connected with a ground unit of the wireless charging converter via the second switch, an output side of the first rectifying circuit is connected with the first electromagnetic compatible circuit, and the DC-DC converter secondary side unit is connected with a secondary side of the isolation transformer; and

wherein when the first switch is closed and the second switch is opened, a high voltage direct current output from a high voltage power battery is converted into a low voltage direct current by the first rectifying circuit and the DC-DC converter secondary side unit; and when the first switch is opened and the second switch is closed, a direct current output from the ground unit of the wireless charging converter is converted, via the first rectifying circuit, into a high voltage direct current to be output to the high voltage power battery.

Preferably, in the above on-vehicle power converter for electric vehicle, the first rectifying circuit and the second rectifying circuit are bridge rectifying circuits.

Preferably, the above on-vehicle power converter for electric vehicle further comprises a filtering capacitor connected at the output sides of the first rectifying circuit and the second rectifying circuit.

Preferably, in the above on-vehicle power converter for electric vehicle, the DC-DC converter secondary side unit comprises a DC-DC secondary side rectifying circuit connected with a secondary side of the first isolation transformer, and a second electromagnetic compatible circuit connected with the DC-DC secondary side rectifying unit.

Preferably, in the above on-vehicle power converter for electric vehicle, the on-vehicle charging converter primary side unit comprises a third electromagnetic compatible circuit, a DC-DC primary side rectifying circuit connected with a primary side of the second isolation transformer, and a power factor correction circuit connected between the third electromagnetic compatible circuit and the DC-DC primary side rectifying circuit.

The on-vehicle power converter for electric vehicle according to another aspect of the invention at least comprises an on-vehicle charging converter and an on-vehicle unit of a wireless charging converter, characterized in that a secondary side of the on-vehicle charging converter and a secondary side of the wireless charging converter share a rectifying circuit, a filtering circuit and an electromagnetic compatible circuit.

Preferably, the on-vehicle power converter for electric vehicle comprises:
a first switch;
a second switch;
an isolation transformer;
the on-vehicle charging converter primary side unit connected with a primary side of the isolation transformer;
a secondary side rectifying circuit; and
an output electromagnetic compatible circuit connected with the secondary side rectifying circuit,
wherein an input side of the secondary side rectifying circuit is connected with a ground unit of a wireless charging converter and a secondary side of the isolation transformer of the on-vehicle charging converter via the first switch and the second switch, respectively; and
wherein when the first switch is closed and the second switch is opened, a direct current output from the ground unit of the wireless charging converter is converted into a high voltage direct current by the rectifying circuit, and when the first switch is opened and the second switch is closed, a direct current output from the on-vehicle charging converter primary side unit is converted into a high voltage direct current by the rectifying circuit.

Further another object of the invention is to provide an electric vehicle which has advantages of compact structure, light weight, small space occupied, etc.

The electric vehicle according to further another aspect of the invention comprises the on-vehicle power converter as above described.

### BRIEF DESCRIPTION OF THE DRAWINGS

The above and/or other aspects and advantages of the invention will become more clear and more easily understood from the following description of various aspects with reference to the accompanying drawings, wherein identical or similar elements are denoted by identical signs in the drawings, in which:

FIG. 1 is a circuit diagram of a wireless charging converter according to the prior art;

FIG. 2 is a circuit diagram of an on-vehicle charging converter according to the prior art;

FIG. 3 is a circuit diagram of a DC-DC converter according to the prior art;

FIG. 4 is a circuit diagram of a multi-functional on-vehicle power converter for electric vehicle according to a first embodiment of the invention;

FIG. 5 is a circuit diagram of a multi-functional on-vehicle power converter for electric vehicle according to a second embodiment of the invention; and

FIG. 6 is a circuit diagram of a multi-functional on-vehicle power converter for electric vehicle according to a third embodiment of the invention.

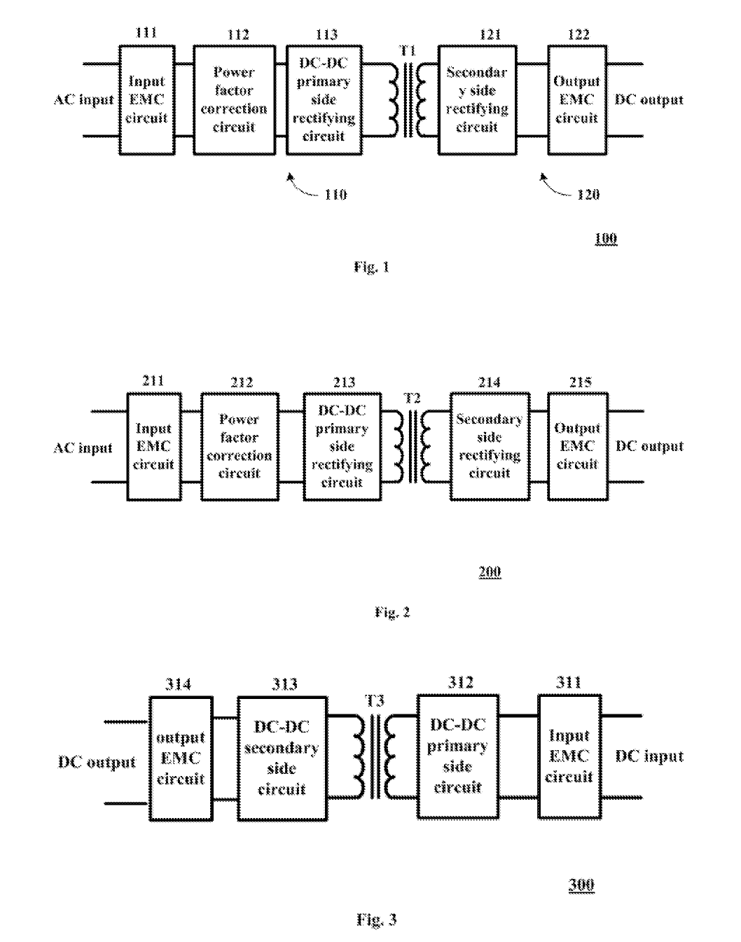

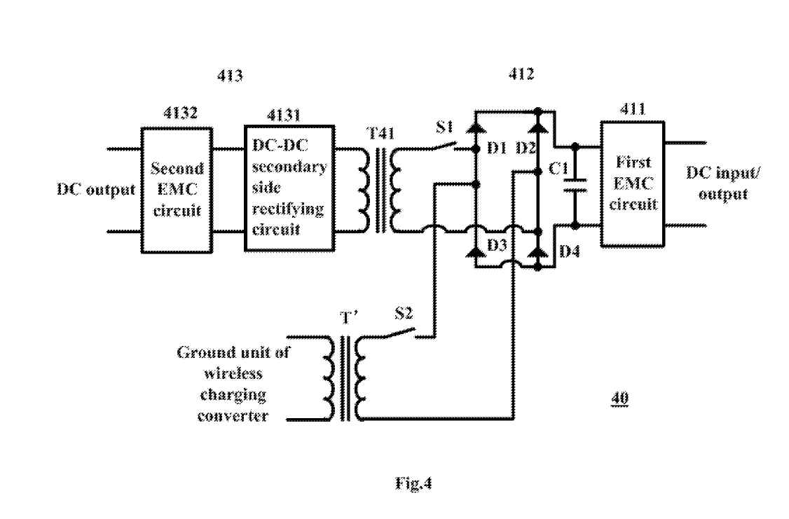

### DETAILED DESCRIPTION OF THE INVENTION

The invention will be described below more fully with reference to the accompanying drawings in which illustrative embodiments of the invention are shown. However, the invention can be carried out in different ways, and should not be construed as being limited to various embodiments given herein. The various embodiments given above are intended to make the disclosure comprehensive and complete so as to enable a more comprehensive and precise understanding of the scope of protection of the invention.

Terms such as “include” and “comprise” or the like mean that in addition to the elements and steps that are directly and explicitly recited in the specification and claims, the technical solutions of the invention do not exclude situations in which other elements and steps that are not directly or explicitly recited are included.

Terms such as “first” and “second” or the like do not represent an order of the elements in terms of time, space, magnitude or the like, and are merely used for distinguishing individual elements from each other.

According to an aspect of the invention, an on-vehicle unit of the wireless charging converter and a high voltage battery side of the DC-DC converter share a set of rectifying circuit, filtering circuit and EMC circuit, wherein the rectifying circuit is connected with a secondary side of an isolation transformer of the ground unit of the wireless charging converter and a primary side of an isolation transformer of the DC-DC converter via two independent switches respectively. Through different combinations of the states of switches, the set of rectifying circuit, filtering circuit and EMC circuit can be used by the wireless charging converter and the DC-DC converter.

According to another aspect of the invention, the on-vehicle charging converter uses an independent rectifying circuit at the secondary side of the isolation transformer thereof, but shares the filtering circuit and the EMC circuit with the wireless charging converter and the high voltage battery side of the DC-DC converter. When the above described two independent switches are both in an open state, the filtering circuit and the EMC circuit can be used by the on-vehicle charging converter.

According to further another aspect of the invention, the on-vehicle unit of the wireless charging converter and the secondary side of the on-vehicle charging converter share a secondary side rectifying circuit, filtering circuit and output EMC circuit, and an input side of the secondary side rectifying circuit are connected with the secondary side of the isolation transformer of the wireless charging converter and the secondary side of the isolation transformer of the on-vehicle charging converter via two independent switches respectively.

The embodiments of the invention will be described specifically below in connection with the accompanying drawings.

### First Embodiment

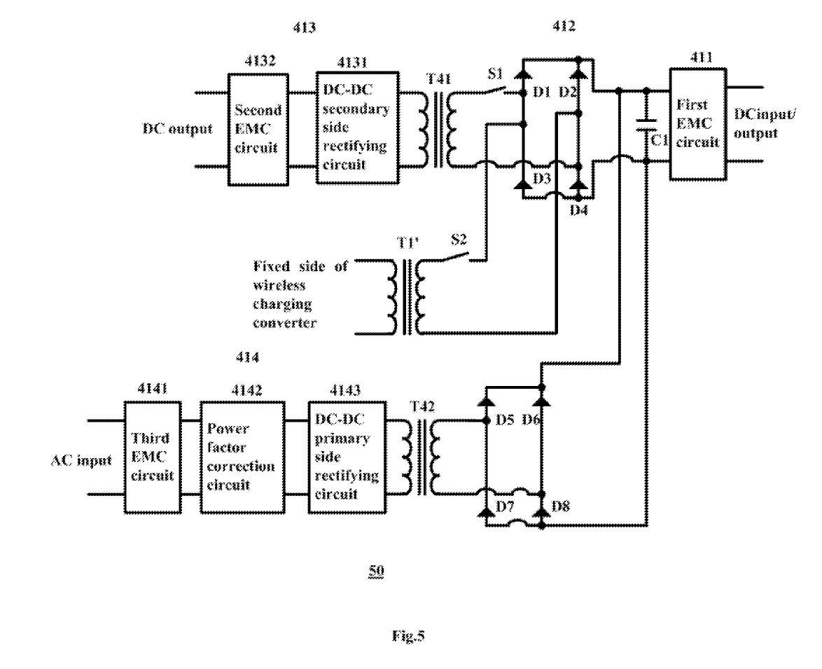

FIG. 4 is a circuit diagram of an on-vehicle power converter for electric vehicle according to a first embodiment of the invention.

The on-vehicle power converter 40 for electric vehicle shown in FIG. 4 comprises a first electromagnetic compatible circuit 411, a first rectifying circuit 412 connected with the first electromagnetic compatible circuit 411, an isolation transformer T, a DC-DC converter secondary side unit 413, a first switch S1 and a second switch S2, wherein the primary side and the secondary side of the isolation transformer T41 are connected with the first rectifying circuit 412 and the DC-DC converter secondary side unit 413 respectively.

In this embodiment, the first rectifying circuit 412 is a bridge rectifying circuit constituted by diodes D1-D4, wherein one of the input ends of the bridge rectifying circuit is connected to the primary side of the isolation transformer T41 and the secondary side of an isolation transformer T′ of a wireless charging converter via the first switch S1 and the second switch S2 respectively, and another input end of the bridge rectifying circuit is directly connected to the primary side of the isolation transformer T41 and the secondary side of the isolation transformer T′. Preferably, the on-vehicle power converter 40 further comprises a filtering capacitor C1 as a filtering circuit, and this capacitor is connected between a positive output end and a negative output end of the bridge rectifying circuit.

It should be pointed out that while the isolation transformer T′ is typically disposed inside a ground unit of the wireless charging converter, such an arrangement is not necessary, and the invention also applies to a situation in which the isolation transformer T′ is integrated in the on-vehicle unit of the wireless charging converter.

In this embodiment, the DC-DC converter secondary side unit 413 comprises a DC-DC secondary side rectifying circuit 4131 connected with the secondary side of the first isolation transformer T41, and a second electromagnetic compatible circuit 4132 connected with the DC-DC secondary side rectifying circuit 4131.

As described above, the on-vehicle unit of the wireless charging converter and the high voltage battery side of the DC-DC converter share a set of rectifying circuit, filtering circuit and EMC circuit. Specifically, in the present embodiment, during wireless charging, the first electromagnetic compatible circuit 411, the filtering capacitor C1 and the first rectifying circuit 412 are used as a secondary side circuit unit of the isolation transformer of the wireless charging converter, whereas when the high voltage power battery is used to supply power to low voltage electrical devices or to charge the low voltage battery, the first electromagnetic compatible circuit 411, the filtering capacitor C1 and the first rectifying circuit 412 are used as a primary side circuit unit of the isolation transformer of the DC-DC converter. A switch between the above two operational modes is realized by controlling the states of the first switch S1 and the second switch S2.

The operational principle of the on-vehicle power converter as shown in FIG. 4 will be described below.

When it is required to use the high voltage power battery to supply power to low voltage electrical devices or to charge the low voltage battery, the first switch S1 is closed and the second switch S2 is opened. At this point, the high voltage direct current output from the high voltage power battery is input to the filtering capacitor C1 and the first rectifying circuit 412 after flowing through the first electromagnetic compatible circuit 411, and a high-frequency direct current is generated at the primary side of the isolation transformer T41 after being filtered and a DC-DC conversion. The DC-DC converter secondary side unit 413 rectifies the high-frequency direct current from the secondary side of the isolation transformer T41 and outputs it to the low voltage electrical devices or the low voltage battery.

When it is required to for example charge the high voltage power battery in a wireless way, the first switch S1 is opened and the second switch S2 is closed. At this point, at the ground unit side of the wireless charging converter, the electrical energy of AC grid is input to the DC-DC primary side circuit after passing through the input electromagnetic compatible circuit and a power factor correction circuit, and a high-frequency direct current is generated at the primary side of the isolation transformer T′ after a DC-DC conversion. The first rectifying circuit 412 rectifies the high-frequency direct current from the secondary side of the isolation transformer T′, the filtering capacitor C1 filters the direct current after rectification, and then the first electromagnetic compatible circuit 411 outputs the direct current filtered by the filtering capacitor C1 to the high voltage power battery.

In the present embodiment, by introducing two independent switches, the on-vehicle part of the wireless charging converter and the DC-DC converter can share a rectifying circuit, a filtering circuit, an output EMC circuit and a corresponding control unit (e.g., a CAN communication circuit and a signal collecting circuit, etc.), and a convenient and swift switch can be realized between the two operational modes. In addition, since a set of circuit units are shared at the secondary side of the isolation transformer T, the number of cooling circuits is also reduced, and the occupied space and weight of the on-vehicle power converter are decreased.

### Second Embodiment

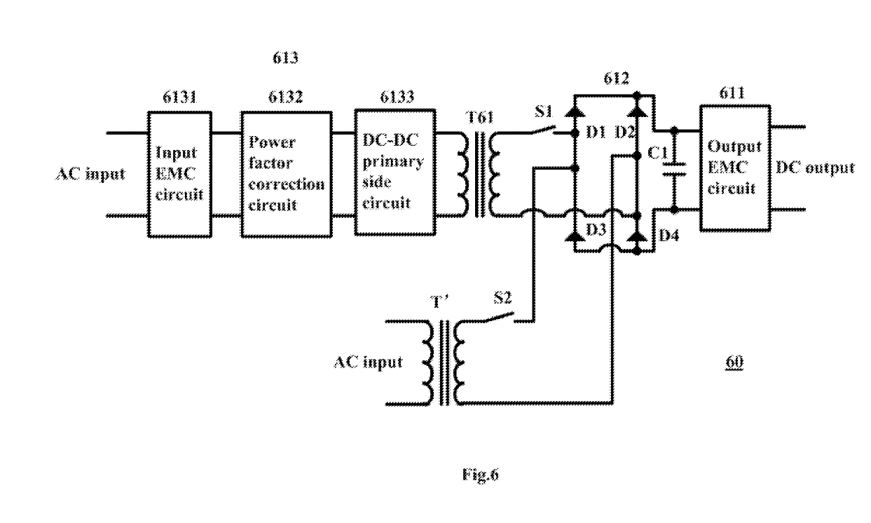

FIG. 5 is a circuit diagram of an on-vehicle power converter for electric vehicle according to a second embodiment of the invention.

The on-vehicle power converter 50 for electric vehicle shown in FIG. 5 comprises a first electromagnetic compatible circuit 411, a first rectifying circuit 412 connected with the first electromagnetic compatible circuit 411, a first isolation transformer T41, a DC-DC converter secondary side unit 413, a second isolation transformer T42, an on-vehicle charging converter primary side unit 414 connected with the primary side of the second isolation transformer T42, a second rectifying circuit 415, a first switch S1 and a second switch S2, wherein the primary side and the secondary side of the first isolation transformer T41 are connected with the first rectifying circuit 412 and the DC-DC converter secondary side unit 413 respectively, and the primary side and the secondary side of the second isolation transformer T42 are connected with the on-vehicle charging converter primary side unit 414 and the second rectifying circuit 415 respectively.

In this embodiment, the first rectifying circuit 412 is a bridge rectifying circuit constituted by diodes D1-D4, wherein one of the input ends of the bridge rectifying circuit is connected to the primary side of the isolation transformer T41 and the secondary side of an isolation transformer T1′ of a wireless charging converter via the first switch S1 and the second switch S2 respectively, and another input end of the bridge rectifying circuit is directly connected to the primary side of the first isolation transformer T41 and the secondary side of the isolation transformer T1′. Preferably, the multi-functional on-vehicle power converter 50 in this embodiment further comprises a filtering capacitor C1 as a filtering circuit, and this capacitor is connected between a positive output end and a negative output end of the bridge rectifying circuit 412.

With continued reference to FIG. 5, the second rectifying circuit 415 is a bridge rectifying circuit constituted by diodes D5-D8, wherein an input end of this bridge rectifying circuit is connected with the second isolation transformer T42, and an output end of this bridge rectifying circuit and an output end of the first rectifying circuit 412 are connected to the filtering capacitor C1 and the first electromagnetic compatible circuit 411 in parallel.

In this embodiment, the DC-DC converter secondary side unit 413 comprises a DC-DC secondary side rectifying circuit 4131 connected with the secondary side of the first isolation transformer T41, and a second electromagnetic compatible circuit 4132 connected with the DC-DC secondary side rectifying circuit 4131.

In this embodiment, the on-vehicle charging converter primary side unit 414 comprises a third electromagnetic compatible circuit 4141, a DC-DC primary side rectifying circuit 4143 connected with the primary side of the second isolation transformer T42, and a power factor correction circuit 4142 connected between the third electromagnetic compatible circuit 4141 and the DC-DC primary side rectifying circuit 4143.

It should be pointed out that while the isolation transformer T1′ is typically disposed inside a ground unit of the wireless charging converter, such an arrangement is not necessary, and the invention also applies to a situation in which the isolation transformer T1′ is integrated in the on-vehicle unit of the wireless charging converter.

As described above, the on-vehicle unit of the wireless charging converter and the high voltage battery side of the DC-DC converter share a set of rectifying circuit, filtering circuit and EMC circuit, and the filtering circuit and EMC circuit are also shared by the on-vehicle charging converter. Specifically, in the present embodiment, during wireless charging, the first electromagnetic compatible circuit 411, the filtering capacitor C1 and the first rectifying circuit 412 are used as the on-vehicle unit of the wireless charging converter; when the high voltage power battery is used to supply power to low voltage electrical devices or to charge the low voltage battery, the first electromagnetic compatible circuit 411, the filtering capacitor C1 and the first rectifying circuit 412 are used as a primary side circuit unit of the isolation transformer of the DC-DC converter; and when charging is performed in a conductive way, the first electromagnetic compatible circuit 411, the filtering capacitor C1 and the second rectifying circuit 415 are used as a secondary side circuit unit of the isolation transformer of the on-vehicle charging converter. A switch among the above three operational modes is realized by controlling the states of the first switch S1 and the second switch S2.

The operational principle of the on-vehicle power converter as shown in FIG. 5 will be described below.

When it is required to use the high voltage power battery to supply power to low voltage electrical devices or to charge the low voltage battery, the first switch S1 is closed and the second switch S2 is opened. At this point, the high voltage direct current output from the high voltage power battery is input to the filtering capacitor C1 and the first rectifying circuit 412 after flowing through the first electromagnetic compatible circuit 411, and a high-frequency direct current is generated at the primary side of the first isolation transformer T41 after a DC-DC conversion. The DC-DC converter secondary side unit 413 rectifies the high-frequency direct current from the secondary side of the isolation transformer T41 and outputs it to the low voltage electrical devices or the low voltage battery.

When it is required to for example charge the high voltage power battery in a wireless way, the first switch S1 is opened and the second switch S2 is closed. At this point, the direct current of the ground unit of the wireless charging converter is coupled to the first rectifying circuit 412 via the isolation transformer T1′, the rectified current is sent to the first electromagnetic compatible circuit 411 after being filtered by the filtering capacitor C1, and is then output to the high voltage power battery.

When it is required to for example charge the high voltage power battery using the on-vehicle charging converter, the first switch S1 is opened and the second switch S2 is also opened. At this point, at the primary side of the on-vehicle charging converter, the electrical energy of AC grid is input to the DC-DC primary side circuit 4143 after passing through the input electromagnetic compatible circuit 4141 and the power factor correction circuit 4142, and a high-frequency direct current is generated at the primary side of the isolation transformer T42 after a DC-DC conversion. The second rectifying circuit 415 rectifies the high-frequency direct current from the secondary side of the isolation transformer T42, the filtering capacitor C1 filters the direct current after rectification, and then the first electromagnetic compatible circuit 411 outputs the rectified direct current to the high voltage power battery.

In the present embodiment, by introducing two independent switches, the rectifying circuit, the filtering circuit, the output EMC circuit and a corresponding control unit (e.g., a CAN communication circuit and a signal collecting circuit, etc.) can be shared among the conductive charging converter, the on-vehicle part of the wireless charging converter and the DC-DC converter, and a convenient and swift switch can be realized among the three operational modes. In addition, since the circuit units are shared, the number of cooling circuits is also reduced, and the occupied space and weight of the on-vehicle power converter are decreased.

### Third Embodiment

FIG. 6 is a circuit diagram of an on-vehicle power converter for electric vehicle according to a third embodiment of the invention.

The on-vehicle power converter 60 for electric vehicle shown in FIG. 6 comprises an output electromagnetic compatible circuit 611, a rectifying circuit 612 connected with the output electromagnetic compatible circuit 611, an isolation transformer T61, a DC-DC converter primary side unit 613, a first switch S1 and a second switch S2, wherein the primary side and the secondary side of the isolation transformer T61 are connected with the DC-DC converter primary side unit 613 and the rectifying circuit 612 respectively.

In this embodiment, the rectifying circuit 612 is a bridge rectifying circuit constituted by diodes D9-D12, wherein one of the input ends of the bridge rectifying circuit is connected to the secondary side of the isolation transformer T61 and the secondary side of an isolation transformer T′ of a wireless charging converter via the first switch S1 and the second switch S2 respectively, and another input end of the bridge rectifying circuit is directly connected to the secondary side of the isolation transformer T61 and the secondary side of the isolation transformer T′. Preferably, the on-vehicle power converter 60 further comprises a filtering capacitor C1 as a filtering circuit, and this capacitor is connected between a positive output end and a negative output end of the bridge rectifying circuit.

It should be pointed out that while the isolation transformer T′ is typically disposed inside a ground unit of the wireless charging converter, such an arrangement is not necessary, and the invention also applies to a situation in which the isolation transformer T′ is integrated in the on-vehicle unit of the wireless charging converter.

In this embodiment, the DC-DC converter secondary side unit 613 comprises an input electromagnetic compatible circuit 6131, a DC-DC primary side rectifying circuit 6133 connected with the primary side of the isolation transformer T61, and a power factor correction circuit 6132 connected between the input electromagnetic compatible circuit 6131 and the DC-DC primary side rectifying circuit 6133.

As described above, the on-vehicle unit of the wireless charging converter and the secondary side of the on-vehicle charging converter share a set of rectifying circuit, filtering circuit and EMC circuit. Specifically, in the present embodiment, during wireless charging, the output electromagnetic compatible circuit 611, the filtering capacitor C1 and the rectifying circuit 612 are used as a secondary side circuit unit of the isolation transformer of the wireless charging converter; and when charging is performed in a conductive way, the output electromagnetic compatible circuit 611, the filtering capacitor C1 and the rectifying circuit 612 are used as a secondary side circuit unit of the isolation transformer of the on-vehicle charging converter. A switch among the above two operational modes is realized by controlling the states of the first switch S1 and the second switch S2.

The operational principle of the charging conversion device as shown in FIG. 6 will be described below.

When it is required to charge using the on-vehicle charging converter, the first switch S1 is closed and the second switch S2 is opened. At this point, the electrical energy of AC grid generates a high-frequency direct current at the primary side of the isolation transformer T61 after the DC-DC converter primary side unit 613. The first rectifying circuit 612 rectifies the high-frequency direct current from the secondary side of the isolation transformer T61, and the output electromagnetic compatible circuit 611 outputs the rectified direct current.

When it is required to charge in a wired way, the first switch 51 is opened and the second switch S2 is closed. At this point, the electrical energy of AC grid is coupled to the rectifying circuit 612 via the isolation transformer T′ of the wireless charging converter, the rectified current is sent to the filtering capacitor C1, and then the filtered direct current is output by the output electromagnetic compatible circuit 611.

In the present embodiment, by introducing two independent switches, the on-vehicle part of the wireless charging converter and the on-vehicle converter can share a rectifying circuit, a filtering circuit, an output EMC circuit and a corresponding control unit (e.g., a CAN communication circuit and a signal collecting circuit, etc.), and a convenient and swift switch can be realized between the two charging modes. In addition, since a set of circuit units are shared at the secondary side of the isolation transformer, the number of cooling circuits is also reduced, and the occupied space and weight of the charging converter are decreased.

While some aspects of the invention have been illustrated and discussed, it should be realized by those skilled in the art that the above aspects can be changed without departing from the principle and spirit of the invention. Therefore, the scope of the invention will be defined by the appended claims and equivalents thereof.

What is claimed is:

1. An on-vehicle power converter for electric vehicle, at least comprising a DC-DC converter, and an on-vehicle unit of a wireless charging converter, characterized in that a primary side of the DC-DC converter and a secondary side of the wireless charging converter share a rectifying circuit, a filtering circuit and an electromagnetic compatible circuit.

2. The on-vehicle power converter for electric vehicle according to claim 1, further comprising an on-vehicle charging converter, and the filtering circuit and the electromagnetic compatible circuit are also shared by a secondary side of the on-vehicle charging converter.

3. The on-vehicle power converter for electric vehicle according to claim 2, comprising a first switch, a second switch, a first isolation transformer, a second isolation transformer, a first electromagnetic compatible circuit, a DC-DC converter secondary side unit connected with a secondary side of the first isolation transformer, an on-vehicle charging converter primary side unit connected with a primary side of the second isolation transformer, a first rectifying circuit and a second rectifying circuit,
wherein an input side of the first rectifying circuit is connected with a primary side of the first isolation transformer via the firs switch, and is connected with a ground unit of the wireless charging converter via the second switch, an input side of the second rectifying circuit is connected with a secondary side of the second isolation transformer, and the output sides of the first rectifying circuit and the second rectifying circuit are connected with the first electromagnetic compatible circuit in parallel; and
wherein when the first switch is closed and the second switch is opened, a high voltage direct current output from a high voltage power battery is converted into a low voltage direct current via the first rectifying circuit and the DC-DC converter secondary side unit; when the first switch is opened and the second switch is closed, a direct current from the ground unit of the wireless charging converter is converted, via the first rectifying circuit, into a high voltage direct current to be output to the high voltage power battery; and when both the first switch and the second switch are opened, a direct current output from the on-vehicle charging converter primary side unit is converted, via the second rectifying circuit, into a high voltage direct current to be output to the high voltage power battery.

4. The on-vehicle power converter for electric vehicle according to claim 2, comprising a first switch, a second switch, an isolation transformer, a DC-DC converter secondary side unit, a first electromagnetic compatible circuit and a first rectifying circuit,
wherein an input side of the first rectifying circuit is connected with a primary side of the isolation transformer via the first switch, and is connected with a ground unit of the wireless charging converter via the second switch, an output side of the first rectifying circuit is connected with the first electromagnetic compatible circuit, and the DC-DC converter secondary side unit is connected with a secondary side of the isolation transformer; and
wherein when the first switch is closed and the second switch is opened, a high voltage direct current output from a high voltage power battery is converted into a low voltage direct current by the first rectifying circuit and the DC-DC converter secondary side unit; and when the first switch is opened and the second switch is closed, a direct current output from the ground unit of the wireless charging converter is converted, via the first rectifying circuit, into a high voltage direct current to be output to the high voltage power battery.

5. The on-vehicle power converter for electric vehicle according to claim 3, wherein the first rectifying circuit and the second rectifying circuit are bridge rectifying circuits.

6. The on-vehicle power converter for electric vehicle according to claim 5, further comprising a filtering capacitor connected at the output sides of the first rectifying circuit and the second rectifying circuit.

7. The on-vehicle power converter for electric vehicle according to claim 3, wherein the DC-DC converter secondary side unit comprises a DC-DC secondary side rectifying circuit connected with a secondary side of the first isolation transformer, and a second electromagnetic compatible circuit connected with the DC-DC secondary side rectifying unit.

8. The on-vehicle power converter for electric vehicle according to claim 3, wherein the on-vehicle charging converter primary side unit comprises a third electromagnetic compatible circuit, a DC-DC primary side rectifying circuit connected with a primary side of the second isolation transformer, and a power factor correction circuit connected between the third electromagnetic compatible circuit and the DC-DC primary side rectifying circuit.

9. An on-vehicle power converter for electric vehicle, at least comprising an on-vehicle charging converter and an on-vehicle unit of a wireless charging converter, characterized in that a secondary side of the on-vehicle charging converter and a secondary side of the wireless charging converter share a rectifying circuit, a filtering circuit and an electromagnetic compatible circuit.

10. An on-vehicle power converter for electric vehicle, characterized by comprising:
a first switch;
a second switch;
an isolation transformer;
an on-vehicle charging converter primary side unit connected with a primary side of the isolation transformer;
a secondary side rectifying circuit; and
an output electromagnetic compatible circuit connected with the secondary side rectifying circuit,
wherein an input side of the secondary side rectifying circuit is connected with a ground unit of a wireless charging converter and a secondary side of the isolation transformer of the on-vehicle charging converter via the first switch and the second switch, respectively; and
wherein when the first switch is closed and the second switch is opened, a direct current output from the ground unit of the wireless charging converter is converted into a high voltage direct current by the rectifying circuit, and when the first switch is opened and the second switch is closed, a direct current output from the on-vehicle charging converter primary side unit is converted into a high voltage direct current by the rectifying circuit.

11. An electric vehicle, characterized by comprising the on-vehicle power converter according to claim 1.

12. An electric vehicle, characterized by comprising the on-vehicle power converter according to claim 2.

13. An electric vehicle, characterized by comprising the on-vehicle power converter according to claim 3.

14. An electric vehicle, characterized by comprising the on-vehicle power converter according to claim 4.

15. An electric vehicle, characterized by comprising the on-vehicle power converter according to claim 5.

16. An electric vehicle, characterized by comprising the on-vehicle power converter according to claim 6.

17. An electric vehicle, characterized by comprising the on-vehicle power converter according to claim 7.

18. An electric vehicle, characterized by comprising the on-vehicle power converter according to claim 8.

19. An electric vehicle, characterized by comprising the on-vehicle power converter according to claim 9.

20. An electric vehicle, characterized by comprising the on-vehicle power converter according to claim 10.
